(19) United States
(12) Patent Application Publication
(10) Pub. No.: US 2016/0193803 A1
(43) Pub. Date: Jul. 7, 2016

(54) SELECTIVE CATALYTIC REDUCTION HOSE

(71) Applicant: CONTITECH SCHLAUCH GMBH, Hannover (DE)

(72) Inventors: Lars Doring, Korbach (DE); Dirk Groteke, Lichtenfels (DE)

(21) Appl. No.: 14/912,051

(22) PCT Filed: Jun. 17, 2014
(86) PCT No.: PCT/EP2014/062610

§ 371 Date: Feb. 12, 2016

(30) Foreign Application Priority Data
Aug. 15, 2013 (DE) 10 2013 108 853.8

(51) Int. Cl. B32B 1/08; B32B 25/18; B32B 25/14; F16L 53/00; B29C 47/00; B29C 47/06; B29C 35/02; F16L 11/10; B32B 25/10; F01N 3/20

(52) U.S. Cl. CPC B32B 1/08; B32B 25/10; B32B 25/18; B32B 25/14; F01N 3/2066; B29C 47/0004; B29C 47/0026; B29C 47/0064; B29C 47/065; B29C 35/0272; F16L 11/10; F16L 53/008; B32B 2262/0261; B32B 2597/00; F01N 2610/14; F01N 2610/02; B29L 2023/005

(57) ABSTRACT

Hoses that in particular are suitable for use in selective catalytic reduction applications, which are flexible and chemically impermeable with a low swelling rate when in contact with aqueous urea solutions require conveying. The hoses be heatable by electrical conductor(s). The hoses may include an insulating internal rubber made of a vulcanized rubber mixture having a blend of ethylene-propylene-diene rubber and chlorobutyl rubber, at least one reinforcement layer disposed upon the insulating internal rubber, and an external rubber made of a vulcanized rubber mixture containing ethylene-propylene-diene rubber, disposed upon the reinforcement layer(s).

### CROSS REFERENCE TO RELATED APPLICATIONS

This application is a continuation application of international patent application PCT/EP2014/062610, filed Jul. 14, 2014, designating the United States and claiming priority from German application 10 2013 108 853.8, filed Aug. 15, 2013, and the entire content of both applications is incorporated herein by reference.

### FIELD OF THE INVENTION

The invention relates to hoses, and in particular, selective catalytic reduction hoses.

### BACKGROUND

This section provides background information to facilitate a better understanding of the various aspects of the disclosure. It should be understood that the statements in this section of this document are to be read in this light, and not as admissions of prior art.

Hoses that transport liquids containing chemicals in practical applications must comply with a number of requirements. One requirement is they must be impermeable to the liquid to be transported. The hose also has to be chemically resistant to the liquid, and exhibit minimal or no swelling in the presence of the liquid. The hose should moreover have maximum flexibility, and be pressure-resistant.

Selective catalytic reduction (SCR) is a term used for a technique involving the reduction of nitrogen oxides in exhaust gases, such as from combustion systems, waste incineration systems, gas turbines, industrial systems, and engines. This technique uses what is known as an SCR catalyst, which can reduce the nitrogen oxides selectively. The reaction requires ammonia, which is admixed with the exhaust gas by way of example in the form of a urea solution.

In Europe, and also elsewhere, vehicles have to comply with ever-stricter exhaust gas standards. A system which is based on the SCR process and which can reduce nitrogen oxides in exhaust gas has therefore been developed for the post-treatment of exhaust gases from vehicle engines, in particular diesel engines. This system uses a urea solution and the SCR catalyst to convert nitrogen oxides present in the exhaust gas into water vapor and nitrogen. This requires that the liquid urea solution is carried in a separate tank and, during operation, injected via a hose line into the exhaust gas by way of a metering unit.

Practical situations in which SCR systems are used are found in commercial vehicles such as trucks and buses, and to some extent also in cars. These systems use an approximately 32.5% aqueous urea solution, specifications for which are defined in standards such as ISO 22241 and DIN 70070, and which is marketed in Europe as AdBlue®. In North America the term diesel exhaust fluid (DEF) is used.

The lines have to be designed in a way that minimizes extraction, from the materials of the lines, of substances that can contaminate the urea solution. Another technical challenge for use in cars is that space available for the installation is generally very restricted. Hose systems are required which comply with these geometric requirements, e.g. permit tight bending radii.

Another problem with use of these urea solutions is the relatively high freezing point, about −11° C. Prolonged standing times and cold periods therefore represent a risk to the performance capability of the system. Heatable lines have therefore been developed in order to provide reliable prevention of freezing. DE-A1-10201920 by way of example describes a multilayer heatable hose incorporating electrical heating conductors.

An important factor in a heatable hose is that the heating conductor is protected by an insulating outer covering. This ensures that the heating conductor does not come into contact with moisture, which leads to corrosion and finally to destruction of the heating conductor. It has been found that even the slightest damage to the insulation leads to points of weakness in the product.

Equipment known as a spark tester is therefore used to test these hose products in order to exclude insulation defects. This applies high voltages to the hose. If dielectric breakdown is recorded here in relation to the metallic conductor, this indicates an insulation defect. This allows defective hose components to be distinguished from others. However, a precondition for the spark-tester test is that the test is not subject to interference from electrically conductive materials or layers present in the system.

Insulating layers are therefore sometimes required in order to provide electrical insulation between the heating conductors and electrically conductive layers. This frequently requires a complex structure, e.g. the use of a two-layer internal rubber. Production of systems of this type is therefore often complicated and expensive.

As such, there exists an ongoing need for development of hoses Selective catalytic reduction with improved properties which overcome at least some of these difficulties, such need met, at least in part, by embodiments according to the following disclosure.

### SUMMARY

Some aspects of the invention include a hose that in particular is suitable for the use in SCR applications, and overcomes the abovementioned difficulties. In particular, the intention is to provide a flexible and impermeable hose that is resistant to chemicals and has a low swelling rate, in particular in respect of aqueous urea solutions which are used in the SCR process and require conveying. A further intention is a hose having improved resistance to temperature change.

A further intention is that the hose also be designed as a heatable hose, where a spark tester can be used to test the heating conductor in the hose for possible insulation defects. A further intention is that the structure of the hose be as simple as possible, so that the manufacturing process can be optimized, thus minimizing production cost. The hose is intended, in some cases, to be amenable to production by a continuous process.

In some aspects, the object has been achieved via a hose that includes, in the following sequence, a) an insulating internal rubber made of a vulcanized rubber mixture including a blend of ethylene-propylene-diene rubber and chlorobutyl rubber, b) at least one reinforcement layer disposed upon the insulating internal rubber, and c) an external rubber made of a vulcanized rubber mixture including ethylene-propylene-diene rubber, disposed upon the reinforcement layer(s).

In one embodiment, the hose also includes at least one electrical heating conductor, arranged between internal rubber and external rubber, preferably between the reinforcement layer(s) and the external rubber. As such, a heatable hose is thus obtained.

In another aspect, a flexible, impermeable, chemical-resistant and swelling-resistant hose is provided, in particular in relation to urea solutions, for example those used in the SCR process. The hose preferably has improved resistance to temperature change, and the external rubber has better protection from discoloration.

The structure of the hose suitable for SCR applications is relatively simple, thus allowing a simplified manufacturing process without production of a second internal layer or intermediate layer. The hoses can therefore be produced in a continuous process. It is possible to use a spark tester to test the hose provided with electrical heating conductors. No additional intermediate layer is required for this purpose. Separation of the heating conductor for connection purposes can readily be achieved.

### BRIEF DESCRIPTION OF THE DRAWING

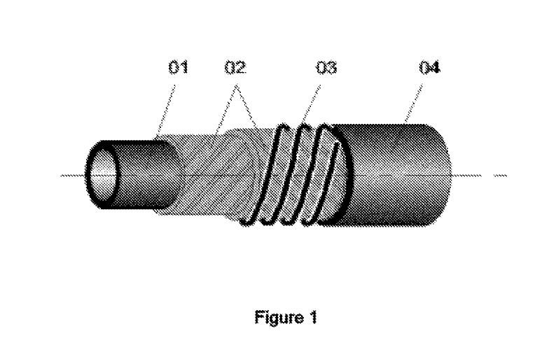

Certain embodiments of the disclosure will hereafter be described with reference to the accompanying drawing, wherein like reference numerals denote like elements. It should be understood, however, that the accompanying FIGURE illustrates the various implementations described herein and are not meant to limit the scope of various technologies described herein, and FIG. 1 illustrates a hose in accordance with an aspect of the disclosure, in a perspective view.

### DETAILED DESCRIPTION

The following description of the variations is merely illustrative in nature and is in no way intended to limit the scope of the disclosure, its application, or uses. The description and examples are presented herein solely for the purpose of illustrating the various embodiments of the disclosure and should not be construed as a limitation to the scope and applicability of the disclosure. While the compositions of the present disclosure are described herein as including certain materials, it should be understood that the composition could optionally include two or more chemically different materials. In addition, the composition can also include some components other than the ones already cited. In the summary of the disclosure and this detailed description, each numerical value should be read once as modified by the term “about” (unless already expressly so modified), and then read again as not so modified unless otherwise indicated in context. Also, in the summary of the disclosure and this detailed description, it should be understood that a concentration or amount range listed or described as being useful, suitable, or the like, is intended that any and every concentration or amount within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors had possession of the entire range and all points within the range.

In addition, use of the “a” or an are employed to describe elements and components of the embodiments herein. This is done merely for convenience and to give a general sense of concepts according to the disclosure. This description should be read to include one or at least one and the singular also includes the plural unless otherwise stated.

The terminology and phraseology used herein is for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited.

Also, as used herein any references to “one embodiment” or “an embodiment” means that a particular element, feature, structure, or characteristic described in connection with the embodiment is included in at least one embodiment. The appearances of the phrase “in one embodiment” in various places in the specification are not necessarily referring to the same embodiment.

In some embodiments, a useful rubber mixture includes one or more rubbers and optionally one or more fillers, a crosslinking agent system, and other additives. The expression “rubber component of the rubber mixture” means the entire quantity of all of the rubbers present in the rubber mixture. The expression “a vulcanized rubber mixture including a rubber” refers to a rubber mixture including a rubber that has been vulcanized, where the rubber then of course is present in vulcanized form. Vulcanization of the rubber mixture gives an elastomer, for which the term rubber is also used. A crosslinking agent system is generally used for the vulcanization process. The expressions “vulcanization” and “crosslinking” are used as synonyms here. A mixture of two different rubbers is also termed a blend.

The unit phr means, as is well known in the field of rubber technology, parts by weight of the respective substance per 100 parts by weight of rubber.

In some aspects, the hose of the invention includes, in this sequence, an insulating internal rubber, at least one reinforcement layer, and an external rubber, and in one embodiment, between the internal rubber and external rubber disposed is at least one electrical heating conductor.

The insulating internal rubber provides the innermost layer of the hose, which during use comes into contact with the medium to be transported. The internal rubber is, in some cases, a single-layer, i.e., between the internal rubber and the reinforcement layer, the arrangement preferably has no second internal rubber/intermediate layer. Such may be made of a rubber or of any other suitable plastic. However, this does not exclude the arrangement of a heating conductor between internal rubber and reinforcement layer. The external rubber protects the hose from environmental effects.

The internal rubber is an insulating rubber. The external rubber can, as desired, be an insulating or non-insulating rubber. A person skilled in the art can formulate rubber layers in accordance with requirements to be electrically insulating or electrically conductive layers. Vulcanized rubbers per se are mostly electrically insulating materials, where the insulation capability can differ with the type of rubber. The layers can be formulated to be electrically conductive by using electrically conductive additives, in particular electrically conductive fillers such as graphite or conductive carbon blacks. In some aspects, a sufficient measure for obtaining an insulating layer is therefore generally to avoid use of any electrically conductive additives such as electrically conductive fillers. Where production of insulating rubber layers uses fillers, it avoids use of those that are electrically conductive, or uses only very small quantities of such.

The expression “insulating materials/rubber” means electrically insulating materials/rubbers, another term that can be used for which is nonconductors. The expression “insulating internal or external rubbers” here preferably means layers with surface resistance >10⁶ ohms, preferably >10¹⁰ ohms, and/or volume resistance >10⁶ ohms, preferably >10¹⁰ ohms. The surface resistance and volume resistance of the rubber layer can be determined in accordance with DIN 53482. Surface resistance is described in 2.1.4 in DIN 53482, and volume resistance is described in 2.1.1 in DIN 53482. Both resistance values, i.e. volume resistance and surface resistance, of the internal rubber mixture used in the invention are preferably greater than 10¹⁰ ohms.

The insulating internal rubber may be made of a vulcanized rubber mixture including a blend of ethylene-propylene-diene rubber and chlorobutyl rubber. Ethylene-propylene-diene rubbers, the usual abbreviation for which is EPDM, and chlorobutyl rubbers, the usual abbreviation for which is CIIR, are conventional types of rubber known to the person skilled in the art, and are obtainable commercially. It is possible to use one or more EPDM rubbers and one or more CIIR rubbers.

EPDM rubbers are copolymers of ethene, propene, and at least one nonconjugated diene, e.g. dicyclopentadiene (DCP), hexadiene (HD), or ethylidenenorbornene (ENB). CIIR rubbers are based on copolymers of isobutene and isoprene (abbreviated symbol IIR) modified via chlorination of double bonds present in the IIR, deriving from the incorporated isoprene.

The ratio by weight of EPDM to CIIR in the rubber mixture for the internal rubber can vary widely. The ratio by weight of EPDM to CIIR in the rubber mixture for the internal rubber can by way of example be in the range from 3:1 to 1:1. With this ratio in the blend it is possible to achieve an ideal compromise between good processability and best permeation rate. The expression “permeation rate” means the quantity, based on time, of liquid which is present in the hose and which is lost via permeation. In some aspects, this should be minimized.

It is generally advantageous that the blend of EPDM and CIIR makes up at least 15% by weight, and preferably at least 45% by weight, of the total weight of the rubber mixture for the internal rubber.

The rubber mixture for the internal rubber can optionally include, alongside the blend of EPDM and CIIR, other types of rubber, but that option is generally not preferred. It is generally preferable that the blend of EPDM and CIIR constitutes at least 90% by weight of the rubber component of the rubber mixture for the internal rubber, and it is more preferable here that the rubber component consists essentially of the blend of EPDM and CIIR. It is particularly preferable that the rubber component of the rubber mixture for the internal rubber consists of the blend of EPDM and CIIR.

Insofar as other rubbers are also optionally used in addition, it is possible to use any of the conventional rubbers known to those persons skilled in the art.

In an embodiment the rubber mixture for the internal rubber includes one or more fillers. The fillers that are conventional for rubber mixtures can be used. Examples of suitable fillers are carbon black and pale-colored fillers such as chalk, silica, kaolin, aluminum silicates, calcium silicates, magnesium silicates, and combinations thereof. Carbon black used can include various types of carbon black for different properties, e.g. reinforcement, extrudability, or coloration. The various types of carbon black are usually classified in accordance with the ASTM standard. Examples of suitable types of carbon black in accordance with the ASTM nomenclature are FEF, GPF, HAF, SRF, lamp blacks, MT blacks, and combinations thereof. FEF black, SRF black, and combinations thereof are suitable for reinforcement here. MT black improves extrudability. The fillers can also be used in the form of surface-modified variants. Surface modification of a filler can by way of example be achieved via reaction of the filler with one or more silanes.

In an embodiment, the rubber mixture for the internal rubber includes at least two fillers, of which at least one filler is a carbon black. The second, or any other, filler can then be another carbon black or a pale-colored filler. In an embodiment, at least one pale-colored filler and at least one dark-colored filler are combined. The dark-colored fillers are carbon black, and the expression “pale-colored fillers” is used for all the other fillers.

The quantitative proportion of filler in the rubber mixture for the internal rubber can vary widely, and can by way of example be within the range from 30 phr to 250 phr, and even from 30 phr to 70 phr.

The rubber mixture for the internal rubber, may in some cases, include a crosslinking agent system. The crosslinking agent system can be one or more crosslinking agents or a combination of crosslinking agent and one or more coagents which by way of example can serve as activators or accelerators.

Examples of suitable crosslinking agents for the rubber mixture for the internal rubber are sulfur and sulfur-donor compounds, peroxides, and phenolic resins, and combinations thereof. Examples of suitable peroxides are alkyl aralkyl peroxides, diaralkyl peroxides, peroxyketals, peroxyesters, and combinations thereof, e.g. dicumyl peroxide, bis(tert-butylperoxyiso-propyl)benzene, and 2,5-bis(tert-butylperoxy)-2,5-dimethylhexane. Examples of phenolic resins are alkyl phenolic resins such as methylol phenolic resins. The person skilled in the art is aware of coagents suitable for the respective crosslinking agents, and can select these as required.

Examples of coagents for crosslinking agents, in particular for peroxides, are allyl compounds, e.g. triallyl cyanurate (TAC), triallyl isocyanurate (TRIC), triallyl phosphate (TAP), triallyl trimellitate (TATM), diallylidenepentaerythritol (DAPE), diallyl terephthalate (DATP); methacrylates, e.g. butylene glycol dimethacrylate (BDMA), ethylene glycol dimethacrylate (EDMA), triethylene glycol dimethacrylate (TEDMA), and trimethylolpropane trimethacrylate (TRIM); zinc salts of methacrylic acid (ZDMA); polybutadiene (BR), in particular 1,2-BR; N,N′-m-phenylenedimaleimide (PDM); and combinations of the coagents mentioned.

In some embodiments, it is particularly preferable to use one or more peroxides as crosslinking agent(s) for the rubber mixture for the internal rubber. Preferred coagents, in particular when peroxides are used, are triallyl cyanurate (TAC), triallyl isocyanurate (TRIC), trimethylolpropane trimethacrylate (TRIM), and combinations thereof.

The quantitative proportion of crosslinking agent in the rubber mixture for the internal rubber can vary widely, depending on the nature of the crosslinking agent, and can by way of example be in the range from 2 phr to 8 phr, and preferably from 3 phr to 5 phr.

The rubber mixture for the internal rubber can moreover, if required, include other additives that are conventional in the rubber mixture sector. Examples of other conventional additives optionally used are plasticizers, metal oxides, aging retarders and other retarders, UV stabilizers and other stabilizers, processing aids, release agents, adhesion promoters, fibers, color pigments, tackifiers, lubricants, and dispersing agents.

The hose of the invention moreover includes at least one reinforcement layer which serves to absorb pressure-related load. Any of the usual reinforcement layers known in the hose production sector can be used for this purpose. The hose can include one or more reinforcement layers, e.g. one or two reinforcement layers.

The reinforcement layer can be a woven fabric, braided fabric, or knitted fabric, preferably made of a textile material. It is preferable that the reinforcement layer is a braided fabric, e.g. a braided textile, steel braid, or glass braid, particular preference being given here to a braided textile. Braided textiles are based on natural and/or synthetic fibers/yarns, which are applied by a braiding process to the internal rubber or to an intermediate layer/second internal rubber that is optionally present. The adhesion between the reinforcement layer(s) and the rubber layers can more advantageously be improved by adhesion promoters which are present in the rubber mixtures or which are applied in the form of an adhesion promoter solution to the respective layers and/or fibers.

The fibers/yarns for the textile reinforcement, in particular for the braided textile, can by way of example be made of polyamide (PA), polyimide (PI), aramid, in particular para-aramid or meta-aramid, polyvinyl acetal (PVA), polyvinyl alcohol (PVAL), cotton (CO), modal (CMD), rayon (CV), polyetherether-ketone (PEEK), polyester, in particular polyethylene terephthalate (PET), or polyethylene 2,6-naphthalate (PEN), polysulfone (PSU), polyoxadiazole (POD), polybenzoxazole (PBO), polyphenylene, or a polyphenylene derivative, in particular a polyphenylene sulfide (PPS). It is also possible to use hybrid systems, e.g. in the form of a mixed yarn with two or more of the materials mentioned.

The fibers/yarns for the textile reinforcement, in particular for the braided textile, are preferably made of polyamide (PA), and particularly preferably of nylon-6,6.

The hose moreover includes an external rubber made of a vulcanized rubber mixture having ethylene-propylene-diene rubber (EPDM rubber). It is possible to use one or more EPDM rubbers. EPDM rubbers have been described above in relation to the internal rubber. The external rubber can be an insulating or non-insulating external rubber.

It is generally advantageous that EPDM rubber makes up at least 10% by weight, and preferably at least 50% by weight, of the total weight of the rubber mixture for the external rubber.

The EPDM rubber can optionally be used in a blend with other types of rubber in the rubber mixture for the external rubber. However, it is generally preferable that the EPDM rubber used is in essence unblended. It is generally preferable that EPDM rubber makes up at least 90% by weight of the rubber component of the rubber mixture for the external rubber, and it is more preferable here that the rubber component consists essentially of EPDM rubber. It is particularly preferable that the rubber component for the external rubber consists of EPDM rubber.

Insofar as other rubbers are also used in addition, it is possible to use any of the conventional rubbers known to the person skilled in the art.

In an embodiment the rubber mixture for the external rubber includes one or more fillers. The fillers that are conventional for rubber mixtures can be used. For examples reference is made to the examples mentioned above in the description of the internal rubber. Preferred fillers used in the rubber mixture for the external rubber are reinforcing and nonreinforcing fillers.

The quantitative proportion of filler in the rubber mixture for the external rubber can vary widely and by way of example can be in the range from 30 phr to 250 phr, and preferably from 30 phr to 70 phr.

The rubber mixture for the external rubber moreover in some cases, preferably includes a crosslinking agent system, i.e. one or more crosslinking agents, or a combination of crosslinking agent and one or more coagents. For examples of suitable crosslinking agents and/or coagents reference is made to the examples mentioned for the internal rubber.

Sulfur, or one or more sulfur-donor compounds, can by way of example be used as crosslinking agent. It is particularly preferable to use one or more peroxides as crosslinking agent for the rubber mixture for the external rubber. Preferred coagents, in particular when peroxides are used, are triallyl cyanurate (TAC), triallyl isocyanurate (TRIC), trimethylolpropane trimethacrylate (TRIM), and combinations thereof.

In the case of one embodiment in which the rubber mixture for the external rubber is crosslinked peroxidically, the resultant vulcanizate is markedly more resistant to temperature change than crosslinked systems using another crosslinking agent such as sulfur or sulfur-donor compounds, i.e. the rubber material continues to remain flexible for a very long time even at relatively high temperatures.

The quantitative proportion of crosslinking agent in the rubber mixture for the external rubber can vary widely, depending on the nature of the crosslinking agent, and can by way of example be in the range from 2 phr to 8 phr, and preferably from 3 phr to 5 phr, in particular when peroxide is used as crosslinking agent.

The rubber mixture for the external rubber can moreover, if required, include other additives that are conventional in the rubber mixture sector. For examples of other conventional additives optionally used reference is made to the examples mentioned in this connection for the rubber mixture for the internal rubber.

Once the rubber mixtures of internal rubber and external rubber have been shaped they are vulcanized conventionally, separately from one another or preferably together, e.g. at elevated temperature and/or elevated pressure, e.g. by means of steam. The vulcanized rubber, or the elastomer, is formed from the rubber mixture by the vulcanization procedure. The conditions for the vulcanization procedure are familiar to the person skilled in the art.

In an embodiment the hose, the SCR hose, includes at least one electrical heating conductor, and a heatable hose is thus obtained. These heating conductors for hose applications are known and are obtainable commercially. The arrangement has the electrical heating conductor(s) between the internal rubber and the external rubber. The arrangement can have one or more heating conductors in the hose. The heating conductor is based on an electrically conductive material, usually a metal or a metal alloy, materials that can be used here being those with relatively high electrical resistivity.

The electrical heating conductor can be composed of an electrically conductive wire or of a twisted/braided strand, preference being given here to a twisted/braided strand. In this case the insulating internal rubber and the insulating outer covering provide the necessary insulation. It is generally preferable, in some cases, that the electrical heating conductor includes an electrically conductive wire or a twisted/braided strand, in either case with an outer covering of an electrically insulating material, e.g. an electrically insulating plastic. Better insulation of the heating conductor is thus ensured.

The electrical heating conductor is arranged between the internal rubber and the external rubber, and can be arranged here between internal rubber and reinforcement layer or between reinforcement layer and external rubber. It can also be incorporated into the reinforcement layer or between the reinforcement layers. In some cases, the electrical heating conductor(s) is/are applied on the reinforcement layer(s), and are thus arranged between the reinforcement layer(s) and external rubber. The ends of the heating conductor can thus be separated from the hose without damage to the reinforcement.

The heating conductor generally extends at least over a portion of the length of the hose. The heating conductor can by way of example be wound helically around the internal rubber or the reinforcement layer. Once production of the hose has been completed, the two ends of the heating conductor can easily be separated from the hose and connected to an electrical connection device which can be used to connect a voltage source. Reference can by way of example be made to DE-A1-10201920 for other advantageous embodiments in relation to the heating conductor in the hose.

The hose can be produced conventionally. Since the structure of the hose is relatively simple, the hose can advantageously be manufactured continuously in a production line. This is simple and saves cost.

The process for the production of the hose includes by way of example the formation of an internal layer made of the vulcanizable rubber mixture for the internal rubber by means of extrusion in a conventional manner in the form of a hose, the application of the at least one reinforcement layer onto the resultant hose, e.g. via knitting processes, braiding processes, or helical winding processes, optionally the application of the heating conductor(s), e.g. via helical or other winding processes, application, by extrusion, of the vulcanizable rubber mixture for the external rubber onto the reinforcement layer and optionally the heating conductor, to obtain a preform, and the vulcanization of the rubber mixtures in the preform to obtain the hose of the invention. As explained previously, the optional heating conductor can instead also be applied before or with the reinforcement layer onto the internal layer. The process described can be carried out continuously in an appropriate production line.

The hose is generally suitable for the transport of liquids. Since the hose is chemically resistant and has low swellability it is also suitable for fluids which include, or are, relatively aggressive chemicals.

The hose of the invention exhibits practically no swelling and excellent chemical resistance particularly in relation to urea and aqueous solutions thereof. Aqueous urea solutions are also found to cause no, or only little, extraction of substances from the hose.

The hose is therefore particularly preferably suitable as SCR hose, and in particular as heatable SCR hose, insofar as the hose also includes a heating conductor. The expression “SCR hose” or “heatable SCR hose” means hoses which are used in the SCR process, in particular for transport of aqueous urea solutions where, as described in the introduction, the SCR process provides selective catalytic reduction of nitrogen oxides in exhaust gases, in particular in vehicles, for example commercial vehicles, for example trucks or buses, or cars. The hose is particularly preferably used for the transport of aqueous urea solutions, in particular as SCR hose.

The invention is now explained in more detail with reference to an exemplary embodiment and to a diagram.

FIG. 1 is a diagram of a hose of the invention. The hose shown in FIG. 1 includes an insulating internal rubber 01 made of a vulcanized rubber mixture, the rubber component of which is composed of a blend of EPDM and CIIR. The volume resistance and surface resistance of the internal rubber are respectively greater than 10¹⁰ ohms. Reinforcements 02 made of a braided polyamide textile are arranged over the internal rubber. Located there over is a wire helix made of metal with an insulating outer cover as heating conductor 03. Arranged there over is an external rubber 04 made of a vulcanized rubber mixture, the rubber component of which is composed of EPDM.

The foregoing description of the embodiments has been provided for purposes of illustration and description. Example embodiments are provided so that this disclosure will be sufficiently thorough, and will convey the scope to those who are skilled in the art. Numerous specific details are set forth such as examples of specific components, devices, and methods, to provide a thorough understanding of embodiments of the disclosure, but are not intended to be exhaustive or to limit the disclosure. It will be appreciated that it is within the scope of the disclosure that individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Also, in some example embodiments, well-known processes, well-known device structures, and well-known technologies are not described in detail. Further, it will be readily apparent to those of skill in the art that in the design, manufacture, and operation of apparatus to achieve that described in the disclosure, variations in apparatus design, construction, condition, erosion of components, gaps between components may present, for example.

Although a few embodiments of the disclosure have been described in detail above, those of ordinary skill in the art will readily appreciate that many modifications are possible without materially departing from the teachings of this disclosure. Accordingly, such modifications are intended to be included within the scope of this disclosure as defined in the claims.

### KEY

1 Internal rubber
2 Reinforcement
3 Heating conductor
4 External rubber

1. A hose comprising,
a) an insulating internal rubber made of a vulcanized rubber mixture comprising a blend of ethylene-propylene-diene rubber and chlorobutyl rubber;
b) an external rubber made of a vulcanized rubber mixture comprising ethylene-propylene-diene rubber; and
c) at least one reinforcement layer disposed between the internal rubber and the external rubber.

2. The hose as claimed in claim 1, wherein at least one electrical heating conductor is disposed between the internal rubber and the external rubber.

3. The hose as claimed in claim 2 wherein at least one electrical heating conductor is disposed between the reinforcement layer(s) and the external rubber.

4. The hose as claimed in claim 1, wherein the ethylene-propylene-diene rubber and the chlorobutyl rubber in the rubber mixture for the internal rubber is mixed in a weight ratio range of from 3:1 to 1:1.

5. The hose as claimed in claim 1, wherein the rubber mixture for the internal rubber comprises at least two fillers, and wherein one filler is a carbon black.

6. The hose as claimed in claim 1, wherein the reinforcement layer is composed of a braided polyamide textile.

7. The hose as claimed in claim 1, wherein the internal rubber is single-layer.

8. The hose as claimed in claim 1, wherein the vulcanized rubber mixture of the external rubber is a rubber mixture vulcanized with one or more peroxides as crosslinking agent.

9. The hose as claimed in claim 1, wherein the vulcanized rubber mixture of the internal rubber is a rubber mixture vulcanized with one or more peroxides as crosslinking agent.

10. The hose as claimed in claim 1, wherein the rubber component of the rubber mixture of the internal rubber consists essentially of a blend of ethylene-propylene-diene rubber and chlorobutyl rubber, and/or the rubber component of the rubber mixture of the external rubber consists essentially of ethylene-propylene-diene rubber.

11. The hose as claimed in claim 1, wherein the hose is an SCR hose.

12. The use of a hose as claimed in claim 1 for the transport of aqueous urea solutions in a vehicle, and wherein the hose exhibits no swelling while in contact with urea.

13. The use as claimed in claim 12, wherein the hose is used in an SCR process.

14. A SCR hose comprising:
a) an insulating internal rubber made of a vulcanized rubber mixture comprising a blend of ethylene-propylene-diene rubber and chlorobut rubber;
b) an external rubber made of a vulcanized rubber mixture comprising ethylene-propylene-diene rubber;
c) at least one reinforcement layer disposed between the internal rubber and the external rubber;
d) at least one electrical heating conductor disposed between the internal rubber and the external rubber; and
e) an electrical connection device affixed to an end of the hose for connecting with voltage source;
wherein the hose exhibits no swelling while in contact with urea.

15. The hose as claimed in claim 14 wherein at least one electrical heating conductor is disposed between the reinforcement layer(s) and the external rubber.

16. The hose as claimed in claim 14 wherein the internal rubber and the external rubber have a surface electrical resistance of >10⁶ ohms.

17. The hose as claimed in claim 14 wherein the internal rubber and the external rubber have a volume electrical resistance of >10⁶ ohms.

18. A method for the production of a hose, the method comprising:
a) extruding a vulcanizable rubber mixture comprising a blend of ethylene-propylene-diene rubber and chlorobutyl rubber to form an internal rubber of a hose;
b) applying of at least one reinforcement layer onto the internal rubber of the hose;
c) extruding a vulcanizable rubber mixture comprising ethylene-propylene-diene rubber onto the reinforcement layer of the hose, thus forming an external rubber on the hose; and,
d) vulcanizing the resultant performed hose;
wherein the method is a continuous process.

19. The method as claimed in claim 18, wherein at least one electrical heating conductor is applied onto the reinforcement layer after the step b).

20. The method as claimed in claim 19, further comprising affixing an electrical connection device affixed an end of the hose in electrical communication with the at least one electrical heating conductor for connecting with a voltage source.
